(19) United States
(12) Patent Application Publication
(10) Pub. No.: US 2010/0285248 A1
(43) Pub. Date: Nov. 11, 2010

(54) HOUSING FOR ELECTRONIC DEVICE AND METHOD FOR MAKING THE SAME

(75) Inventors: JIN-QIANG ZHU, Shenzhen City (CN); XIAO-BING ZHANG, Shenzhen City (CN); YING-LEI HE, Shenzhen City (CN); YU-QI SHEN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/607,308

(22) Filed: Oct. 28, 2009

(30) Foreign Application Priority Data
May 7, 2009 (CN) 200910302149.4

(51) Int. Cl. B32B 1/00; B05D 7/22

(52) U.S. Cl. 428/34.1; 427/230

(57) ABSTRACT

A housing for an electronic device and a method for making the same are disclosed, the housing comprises a transparent base layer including an inner surface and an outer surface, an opaque screen ink layer printed on the inner surface of the base layer and surrounding a display screen, a transparent outer ink layer printed on substantially the entire outer surface of the base layer to protect the base layer.

### BACKGROUND

1. Field of the Invention

The present disclosure generally relates to housings for electronic devices, more particularly, to a housing for an electronic device and a method for making the same.

2. Description of related art

Currently, portable electronic devices with wireless communication capability, such as mobile phones, are widely used. Consumers often select a portable electronic device with good quality and an attractive appearance. A typical method for making an attractive housing for the portable electronic device is the In-Mold Labeling (IML) process. The process is carried out by molding a plastic substrate to combine with a plastic film in a mold. Before molding, a pattern is printed on the plastic film. After the molding, the pattern is sandwiched between the film and the molded plastic substrate and thus prevents it from erosion.

However, during the molding process, the film is bent with a three-dimensional structure to mate with the three dimensional plastic substrate. The film is generally thin and is prone to tear or be distorted.

Therefore, there is room for improvement within the art.

### BRIEF DESCRIPTION OF THE DRAWINGS

Many aspects of the disclosed the housing for electronic device and method for making the same can be better understood with reference to the following drawings. These drawings are not necessarily drawn to scale, the emphasis instead being placed upon clearly illustrating the principles of the exemplary the housing for electronic device and method for making the same. Moreover, in the drawings like reference numerals designate corresponding parts throughout the several views. Wherever possible, the same reference numbers are used throughout the drawings to refer to the same or like elements of an embodiment.

FIG. 1 is schematic view of an exemplary embodiment of a housing for an electronic device.

FIG. 2 is a partly sectional view of the housing shown in FIG. 1.

FIG. 3 is a flowchart for fabricating the housing shown in FIG. 1.

### DETAILED DESCRIPTION OF THE EMBODIMENT

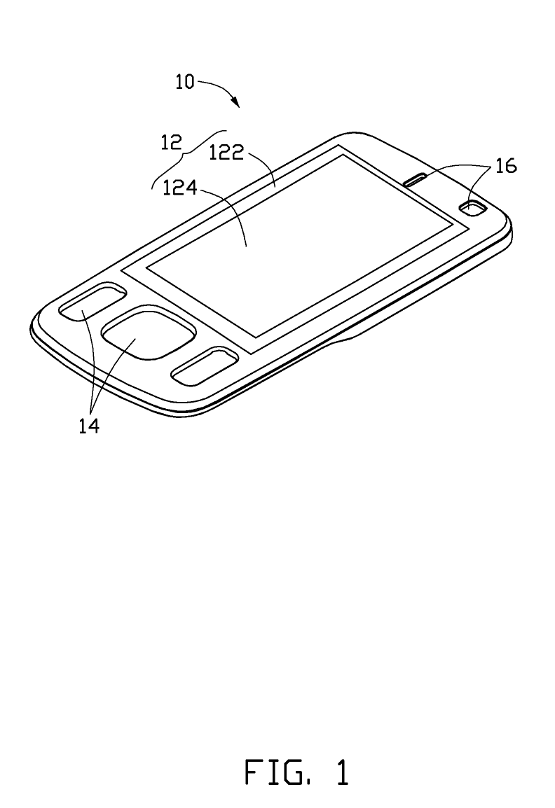

The exemplary housing 10 as disclosed is suitable for an electronic device such as a mobile phone, portable computer, and other devices. FIG. 1 shows the housing 10 having a display screen 12 formed on the outside surface, a plurality of first holes 14 defined at one side of the display screen 12 and a plurality of second holes 16 defined at another side of the display screen 12. The display screen 12 includes a screen area 124 to display image and an ink area 122 surrounding the screen area 124. The first holes 14 can arrange keys therein, and the second holes 16 can arrange camera modules, or receivers, or speakers or microphones etc. therein.

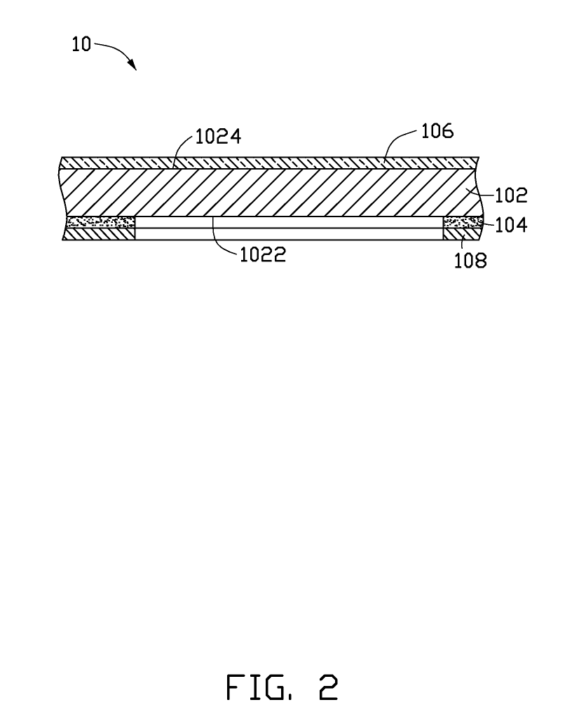

Referring to FIG. 2, the housing 10 includes a transparent base layer 102, an opaque screen ink layer 104, a transparent outer ink layer 106, and an opaque bottom ink layer 108. The base layer 102 can be made of thermoplastic macromolecule material such as polycarbonate, polyethylene terephthalate or a combination thereof. The base layer 102 has an inner surface 1022 and an opposite outer surface 1024. The screen ink layer 104 is printed on portions of the inner surface 1022, accordingly forming the ink area 122 surrounding the screen area 124. The outer ink layer 106 is printed on the outer surface 1024. The outer ink layer 106 should have a superior wear-resistant and corrosion-resistant capabilities to protect the base layer 102. The bottom ink layer 108 is printed on over of screen ink layer 104 and the periphery (not shown) of the screen ink layer 104 to cooperatively expose the screen area 122. The bottom ink layer 108 shields inside light within the portable electronic device and thus the inside light (e.g., from a back-light) cannot leak out of the housing 10.

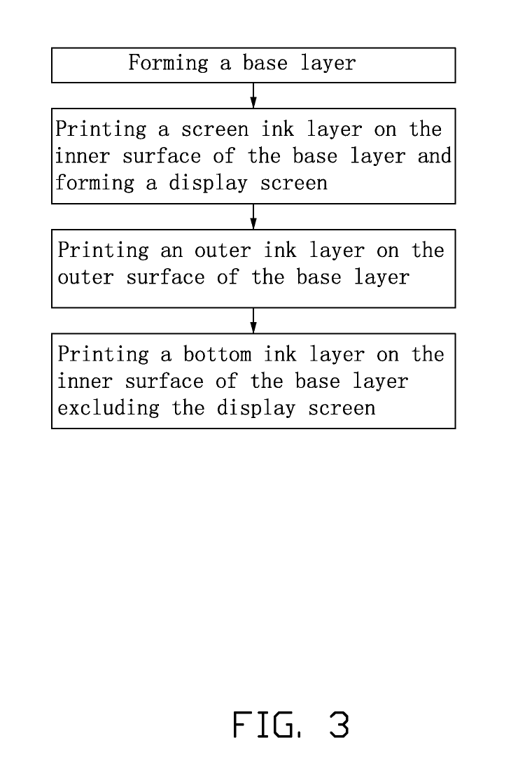

Referring to FIG. 3, to fabricate the housing 10, the base layer 102 can be formed by an injection molding. The base layer 102 has the inner surface 1022 and the outer surface 1024. Using a transparent ink, the outer ink layer 106 is formed on substantially the entire surface of the outer surface 1024. Using an opaque ink, the screen ink layer 104 is formed on a portion of the inner surface 1022. Thus, the ink area 124 and the screen area 122 are formed. The inner surface 1022, excluding the screen area 122, is printed on using an opaque ink, forming the bottom ink layer 108. Because the screen ink layer 104 is opaque and can shield the inside light, the bottom ink layer 108 can be printed without covering the screen ink layer 104.

It is to be understood that the steps to fabricate the housing 10 can be changed, such as the screen ink layer 104 can be formed on the inner surface 1022, and then the bottom ink layer 108 is formed, and finally the outer ink layer 106 is formed.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A housing for an electronic device, comprising:
a transparent base layer including an inner surface and an outer surface;
an opaque screen ink layer printed on a portion of the inner surface of the base layer and surrounding a display screen;
a transparent outer ink layer printed on substantially the entire outer surface of the base layer to protect the base layer.

2. The housing as claimed in claim 1, wherein the housing also includes an opaque bottom ink layer, the bottom ink layer is printed on over of the screen ink layer and a periphery of the screen ink layer.

3. The housing as claimed in claim 1, wherein the base layer is made of thermoplastic macromolecule material.

4. A method of making a housing for an electronic device, comprising the steps of:
forming a transparent base layer having an inner surface and an opposite outer surface;
printing an opaque screen ink layer on a portion of the inner surface of the base layer and surrounding a display screen;
printing a transparent outer ink layer on substantially the entire outer surface of the base layer.

5. The method of making a housing as claimed in claim 4, wherein a bottom ink layer is printed on the remaining portion of the inner surface of the base layer, excluding the display screen, before printing the transparent outer ink layer.

6. The method of making a housing as claimed in claim 5, wherein the bottom ink layer is not printed on over the opaque screen ink layer.

7. The method of making a housing as claimed in claim 4, wherein a bottom ink layer is printed on the remaining portion of the inner surface of the base layer, excluding the display screen, after printing the transparent outer ink layer.

8. The method of making a housing as claimed in claim 7, wherein the bottom ink layer is not printed on over the opaque screen ink layer.

9. The method of making a housing as claimed in claim 4, wherein the base layer is made of thermoplastic macromolecule material.
